(19) United States
(12) Patent Application Publication
(10) Pub. No.: US 2003/0079706 A1
(43) Pub. Date: May 1, 2003

(54) Model engine axle end start converter

(76) Inventor: Brian G. Muehlbauer, Orlando, FL (US)

Correspondence Address: Edward M. Livingston, Esq., 628 Ellen Dr., P.O. Box 1599, Winter Park, FL, 32790, US

(21) Appl. No.: 09/983,957

(22) Filed: Oct. 25, 2001

(51) Int. Cl. F02N 17/00

(52) U.S. Cl. 123/179.25

(57) ABSTRACT

A model engine axle-end start converter has a replacement start shaft (1) and adaptor plate (2) to replace an O.S.® pull-start shaft (6) on a conversional model engine (7) that includes the O.S.® model engine and to position an external converter one-way clutch (8) that includes a Traxxas® one-way clutch on an axle portion 10 of the replacement start shaft. It is made available in a converter package a (4) for handling and for merchandising. The converter package contains assembly instructions (5) for replacing the pull starter (14) of the O.S.® model engine with the EZ electric starter (9) for use on model race cars that include the Traxxas® model truck (13).

### BACKGROUND OF THE INVENTION

This invention relates to converting from a pull starter to an electric starter on model engines having an axle end of a start shaft for use primarily on model cars which are known also as model trucks and model racers.

Remote-controlled model cars and trucks that resemble miniature all-terrain vehicles and trade-known as trucks or racers are popular worldwide. The model cars, trucks and racers, referred to hereafter as model trucks, are about eighteen inches long, fourteen inches wide, seven inches high and have high-traction tires with a diameter of about six inches. Mobile power and control are provided by model engines and remote control similar to model airplanes.

Some of the more popular model trucks have electric starters on model engines that are not as powerful and preferred as widely by their owners as a selection of more powerful model engines that are being produced to satisfy market demand of enthusiastic owners for more model-engine power. The more powerful model engines fit onto the more popular model trucks, but have pull starters that are less desirable and cannot use the electric starter that is produced for and that is marketed as a component of the more popular model trucks.

Some of the model engines that are more powerful than a model engine used on a popular model truck are used on model airplanes, but without the desirable electric starter used on the popular model truck.

This invention makes it possible for a particular class or structure of the more powerful model engines not only to use the electric starters of the more popular model trucks, but also to fit onto the more popular model trucks with the popular electric starter attached. The particular class or structure of the model engines to which this invention applies have a start shaft with an axle for an external one-way clutch on a starter end and a crank plate that is part of a split crankshaft on a crankshaft end.

This class of model engines is distinguished from a class of model engines having a start shaft with interlock shoulders on a starter end and a one-way-clutch axle on a crankshaft end. The one-way-clutch axle fits into an internal one-way clutch having a crank plate on a crankshaft end.

There is no known adaptor for converting from pull start to electric start of model engines in a manner taught by this invention and, therefore, none provided as a converter package taught by this invention.

Examples of most-closely related known but different devices are described in the following patent documents:

| U.S. Pat. No. | Inventor | Issue Date |
|---|---|---|
| 5,765,438 | Chang | Jun. 16, 1998 |
| 3,321,985 | Wheeler | May 30, 1967 |
| 2,939,448 | Hansen | Jun. 7, 1960 |
| 2,553,930 | Moody | May 22, 1951 |
| 4,274,292 | Arnett, Jr. | Jun. 23, 1981 |

### SUMMARY OF THE INVENTION

Objects of patentable novelty and utility taught by this invention are to provide a model engine axle-end start converter which:

makes it possible to use model-engine electric starters of a class that includes a Traxxas® electric starter for starting a class of model engines that includes an O.S.® model engine;

makes it possible to use O.S.® model engines having Traxxas® electric starters on Traxxas® model trucks and racers;

is quick and easy to install;

contains descriptive and illustrative assembly instructions; and

can be made available in a kit for convenient purchase and use.

This invention accomplishes these and other objectives with a model engine axle-end start converter having a replacement start shaft and adaptor plate to replace an O.S.® pull-start shaft on a conversional model engine that includes the O.S.® model engine and to position an external one-way clutch that includes a Traxxas® one-way clutch on an axle end of the replacement start shaft. It is made available in a converter package for handling and for merchandising. The converter package contains assembly instructions for replacing the pull starter of the O.S.® model engine with an EZ electric starter for use on model race cars that include the Traxxas® model truck.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a front elevation view of a converter package for containing an axle-end starter converter;

FIG. 2 is a side view of a replacement start shaft;

FIG. 3 is a front elevation view of an adaptor plate;

FIG. 4 is a section view of the adaptor plate taken through section line 3-3 of FIG. 3;

FIG. 5 is a combined top and side view of fastener bolts for fastening a Traxxas® electric starter onto the O.S.® model engine with the adaptor plate included between them;

FIG. 6 is a representation of a set of instructions;

FIG. 7 is a crankshaft-end view of a crank plate for a class of model engines, including the Traxxas® model engine and the O.S.® model engine, which have crank plates with substantially equal dimensions and, therefore allow interchangeability of crank-plate portions of starting shafts;

FIG. 8 is a starter-end view of the replacement start shaft for the O.S.® model engine;

FIG. 9 is a starter-end view of a standard, prior-art pull-start shaft for the O.S.® model engine;

FIG. 10 is a side view of the standard, prior-art pull-start shaft for the O.S.® model engine;

FIG. 11 is a side view of a standard, prior-art O.S.® one-way clutch on the standard, prior-art pull-start shaft for the O.S.® model engine;

FIG. 12 is a front view of a standard, prior-art O.S.® one-way clutch;

FIG. 13 is a side view of a standard, prior-art Traxxas® start shaft;

FIG. 14 is a front view of a standard, prior-art Traxxas® one-way clutch;

FIG. 15 is a side view of the replacement start shaft on which a Traxxas® one-way clutch is positioned;

FIG. 16 is an attachment-side view of a standard Traxxas® electric starter;

FIG. 17 is a partially cutaway side view of the O.S.® model engine on which a standard, prior-art pull starter, including the pull-start shaft, for the O.S.® model engine is positioned;

FIG. 18 is the FIG. 16 illustration with the standard, prior-art pull-start shaft and a rear adaptor removed to reveal a crank axle of a split crankshaft of conventional model engines;

FIG. 19 is a partially cutaway side view of the standard, prior-art pull-start shaft positioned in the rear adaptor of the O.S.® model engine;

FIG. 20 is a partially cutaway side view of the replacement start shaft positioned in the rear adaptor of the O.S.® model engine;

FIG. 21 is a partially cutaway side view of the O.S.® model engine in which the replacement start shaft is positioned in the rear adaptor;

FIG. 22 is a front view of the O.S.® model engine showing the replacement start shaft positioned ready for positioning of the Traxxas® one-way clutch and attachment of the Traxxas® electric starter;

FIG. 23 is a partially cutaway side view of the O.S.® model engine in which the replacement start shaft is positioned in the rear adaptor and onto which the adaptor plate is fastened in readiness to receive the Traxxas® one-way clutch which is shown to the right;

FIG. 24 is a side view of the Traxxas® electric starter positioned in readiness to be fastened to the adaptor plate and the rear adaptor;

FIG. 25 is a partially cutaway side view of the O.S.® model engine showing the replacement start shaft positioned in the rear adaptor, the adaptor plate fastened, the Traxxas® one-way clutch positioned and the Traxxas® electric starter fastened in assembly for use on the O.S.® model engine;

FIG. 26 is an end view of the FIG. 25 illustration with the Traxxas® electric starter fastened in assembly for use on the O.S.® model engine;

FIG. 27 is a top view of a Traxxas® model truck on which the O.S.® model engine is shown with the Traxxas® electric starter fastened in assembly for use;

FIG. 28 is a fragmentary top view of a Traxxas® model truck on which the Traxxas® model engine is shown with the Traxxas® electric starter fastened in assembly prior to removal for disassembly to obtain the Traxxas® one-way clutch for use on the O.S.® model engine with the Traxxas® electric starter in order to replace the Traxxas® model engine with the O.S.® model engine using the Traxxas® electric starter on the Traxxas® model truck; and

FIG. 29 is a partially cutaway side view of the Traxxas® model engine in disassembling relationship to the Traxxas® one-way clutch and the Traxxas® electric starter in order to obtain the Traxxas® one-way clutch for use on the O.S.® model engine with the Traxxas® electric starter.

### DESCRIPTION OF PREFERRED EMBODIMENT

Listed numerically below with reference to the drawings are terms used to describe features of this invention. These terms and numbers assigned to them designate the same features throughout this description.

```
  1. Replacement start shaft
  2. Adaptor plate
  3. Fasteners
  4. Converter package
  5. Assembly instructions
  6. Pull-start shaft
  7. Conversional model engine
  8. Converter one-way clutch
  9. Electric starter
10. Axle portion
11. Rear adaptor
12. Bearing portion
13. Model truck
14. Pull starter
15. Pull-start clutch
16. Interchangeable model engine
17. Traxxas ® start shaft
18. Closure seal
19. Crankshaft end
20. Starter end
21. Crank plate
22. Crankshaft
23. Crank axle
24. Connecting rod
25. Piston
26. Crank-axle bay
27. Plate bearing
28. Starter coupling
29. One-way clutching members
30. Clutch-coupling shoulders
31. Starter plate
32. Starter-attachment orifice
33. Plate-attachment orifice
34. Plate countersink
```

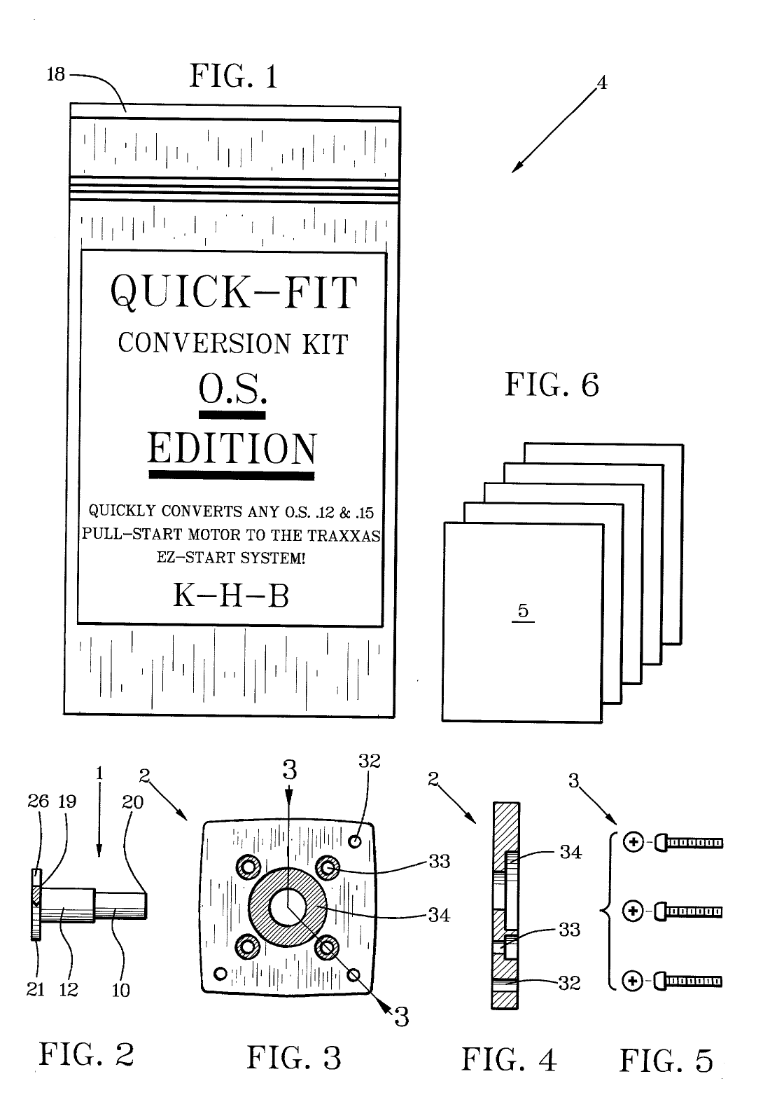

Referring to FIGS. 1-5, the model engine axle-end start converter includes a replacement start shaft 1 and an adaptor plate 2 with fasteners 3 that are optional for a converter package 4 that can be used for containing the model engine axle-end start converter for convenience of pre-assembly handling, for containing assembly instructions 5 and for marketing.

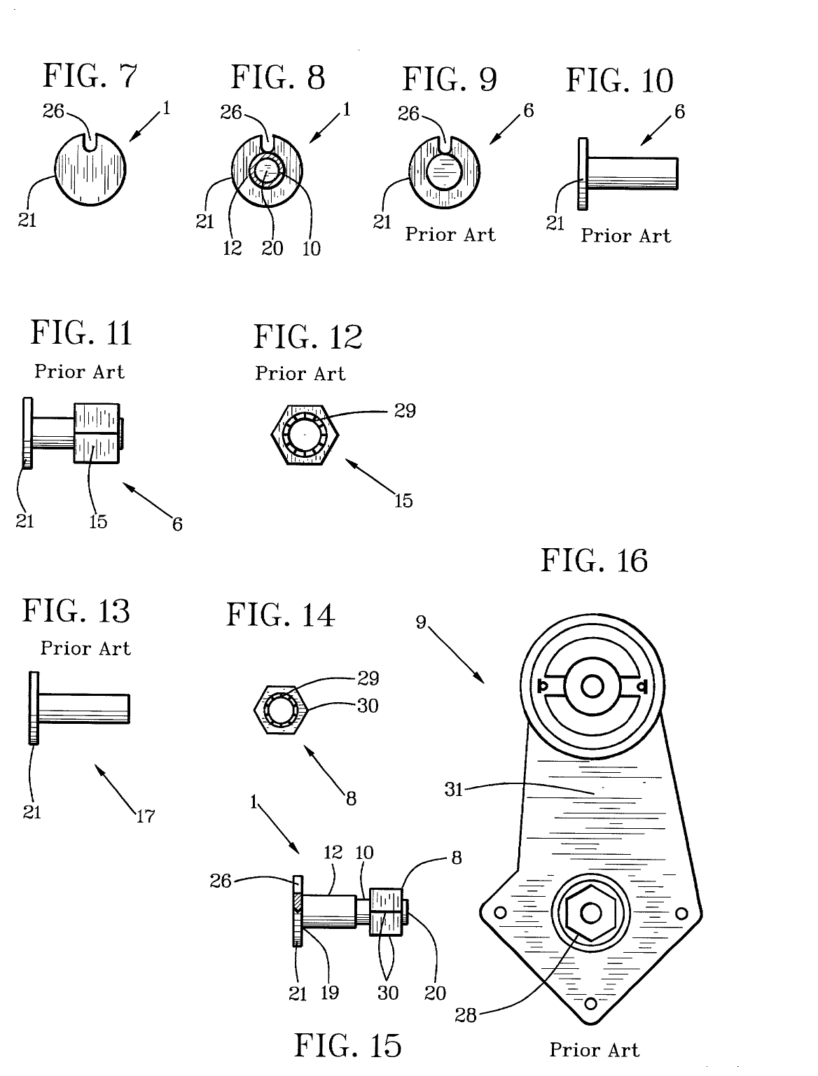

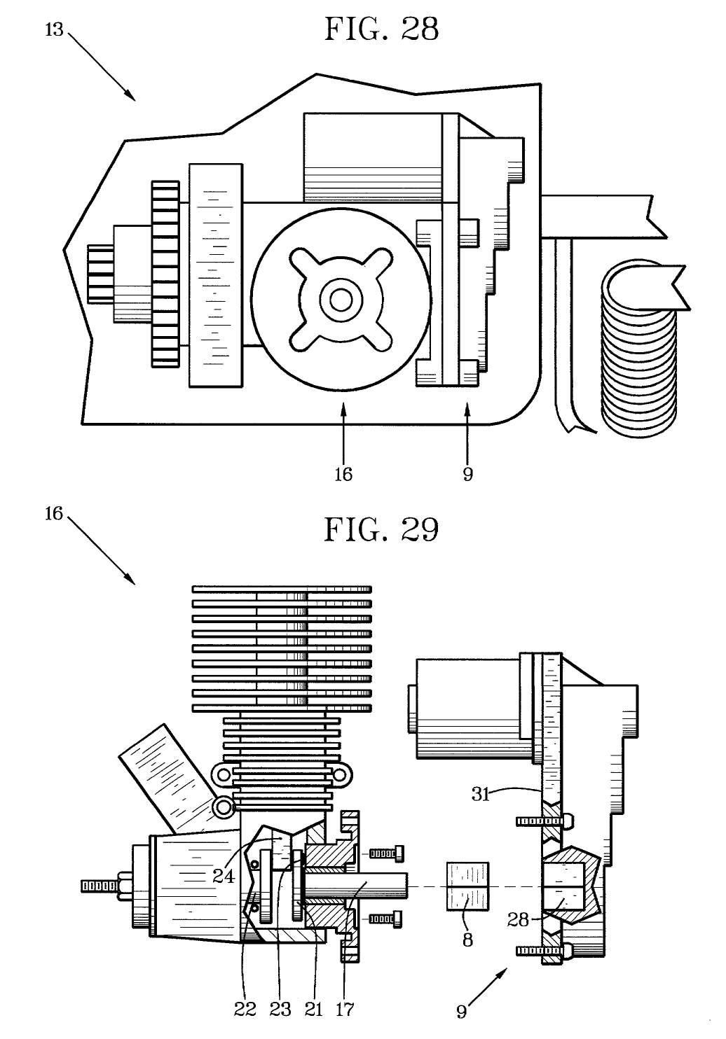

Referring to FIGS. 1-18, the replacement start shaft 1 is articulated to replace a pull-start shaft 6 on a conversional model engine 7. The replacement start shaft 1 receives an external one-way clutch 8 for a predetermined electric starter 9 on an axle portion 10 and receives a rear adaptor 11 of the conversional model engine 7 on a bearing portion 12. The adaptor plate 2 is articulated to position the predetermined electric starter 9 on the conversional model engine 7 for use on a model truck that can include a Traxxas® model truck 13 that is shown in FIGS. 28-29. The converter one-way clutch 8 is articulated for being in coupling communication intermediate the replacement start shaft 1 and the predetermined electric starter 9. The fasteners 3 are attachment bolts having lengths and machine threading for fastening the predetermined electric starter 9 and the adaptor plate 2 to the conversional model engine 7.

The conversional model engine 7 includes an O.S.® model engine as a particular class having a start shaft with an axle for a one-way clutch on a starter end and a crank plate that is part of a split crankshaft on a crankshaft end. The replacement start shaft 1 is articulated to replace an O.S.® pull-start shaft 6 on the O.S.® model engine and to receive the converter one-way clutch 8 which includes a Traxxas® one-way clutch or an equivalent thereof on the axle portion 10 of a starter end 20 of the replacement start shaft 1. The predetermined electric starter 9 includes a Traxxas® electric starter, an equivalent thereof or a predetermined replacement thereof. The adaptor plate 2 is articulated to position the electric starter 9 on the O.S.® model engine for use on a desired model truck that can include the Traxxas® model truck 13. The fasteners 3 are attachment bolts having lengths and machine threads for fastening the adaptor plate 2 and the electric starter 9 to the conversional model engine 7 which can include the O.S.® model engine.

A pull starter 14, also known as a recoil starter, that may be on the conversional model engine 7 as original equipment, generally includes a pull-start clutch 15 that does not fit the electric starter 9. A purpose of this invention is to remove the pull starter 14, the pull-start shaft 6 and the pull-start clutch 15 from the conversional model engine 7 for replacement by the replacement start shaft 1 and the converter one-way clutch 8. Accordingly, the converter one-way clutch 8 can be obtained from an interchangeable model engine 16 which can include a Traxxas® model engine having a Traxxas® start shaft 17 on which the converter one-way clutch 8 fits.

FIG. 28 depicts the interchangeable model engine 16 as the Traxxas® model engine on the Traxxas® model truck 13. FIG. 29 depicts the Traxxas® model engine with the converter one-way clutch 8 being removed from coupling communication intermediate the Traxxas® model engine as the interchangeable model engine 16 and the predetermined electric starter 9 which can include the Traxxas® electric starter.

The converter package 4 can be designated as a start converter for fitting a Traxxas® electric starter 9 on an O.S.® conversional model engine 7 for use on a Traxxas® model truck 13.

The assembly instructions 5 can contain explanations for:

removal of an O.S.® pull-start shaft 6 from the conversional model engine 7 which includes the O.S.® model engine and for replacement of the O.S.® pull-start shaft 6 with the replacement start shaft 1;

removal of the Traxxas® one-way clutch as the converter one-way clutch 8 from the Traxxas® model engine as the interchangeable model engine 16 for use on the replacement start shaft 1, the Traxxas® one-way clutch being removed from a Traxxas® start shaft 17;

placement of the Traxxas® one-way clutch as the converter one-way clutch 8 on the replacement start shaft 1; and

attaching the Traxxas® electric starter as the predetermined electric starter 9 to the O.S.® conversional model engine 7 which contains the replacement start shaft 1 and the Traxxas® one-way clutch 8.

The converter package 4 can be a see-through plastic container that is reclosable and can include a closure seal 18 for indicating prior opening of the converter package 4 that has been opened.

Contents of the assembly instructions 5 are depicted by a plurality of sheets in FIG. 6.

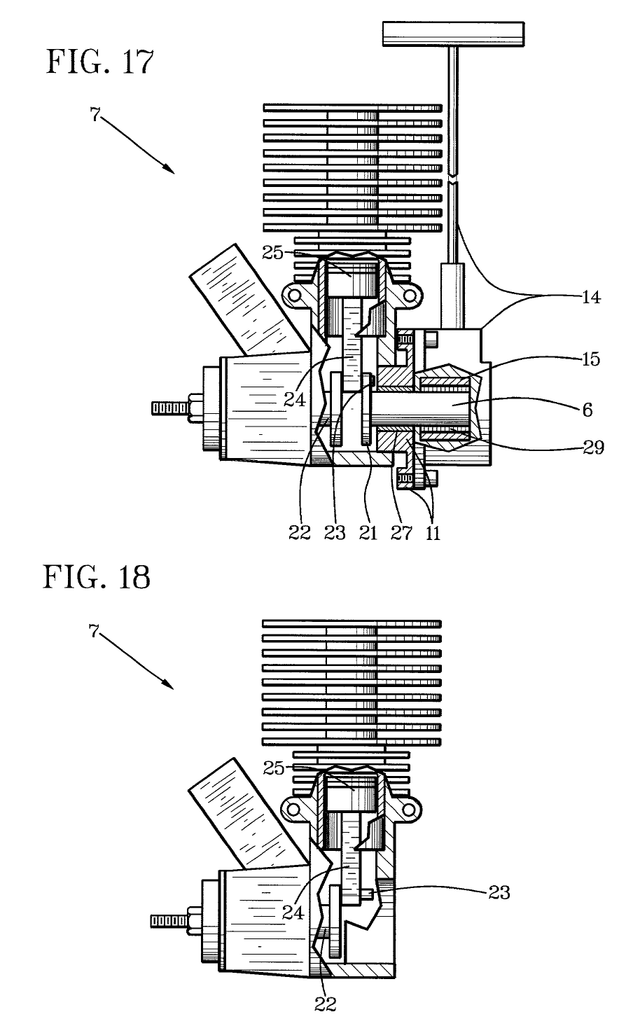

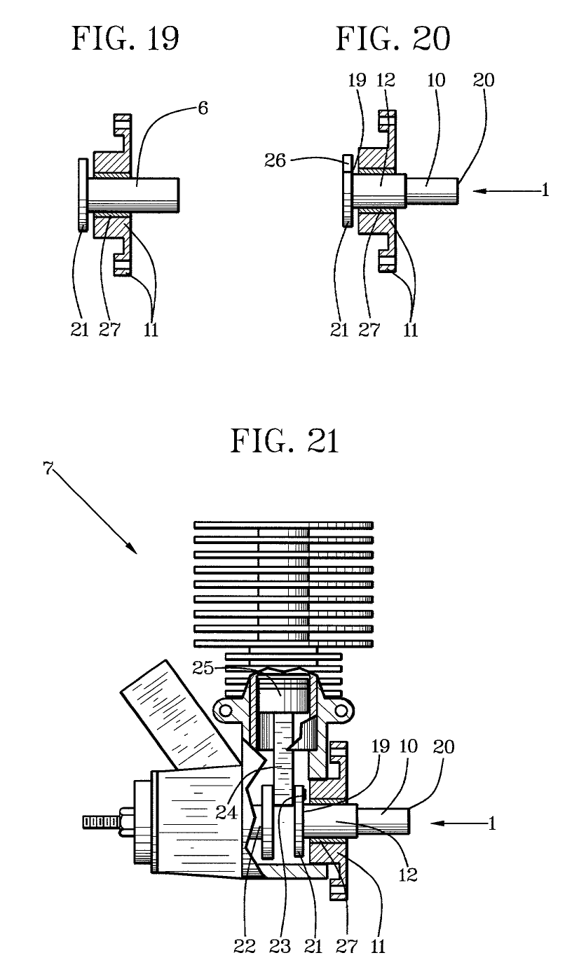

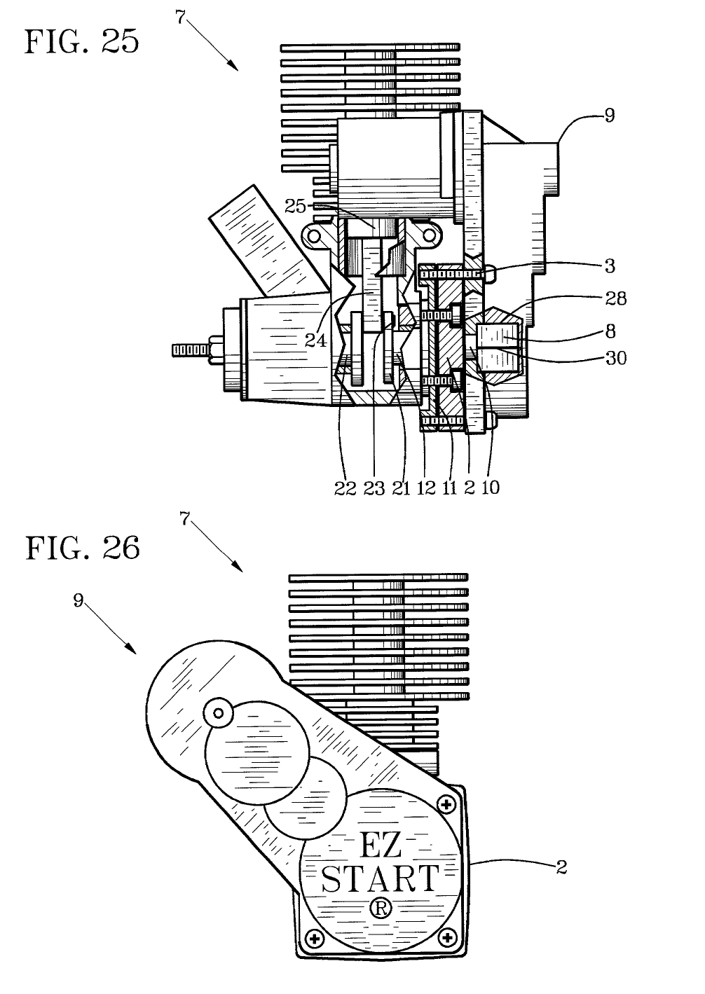

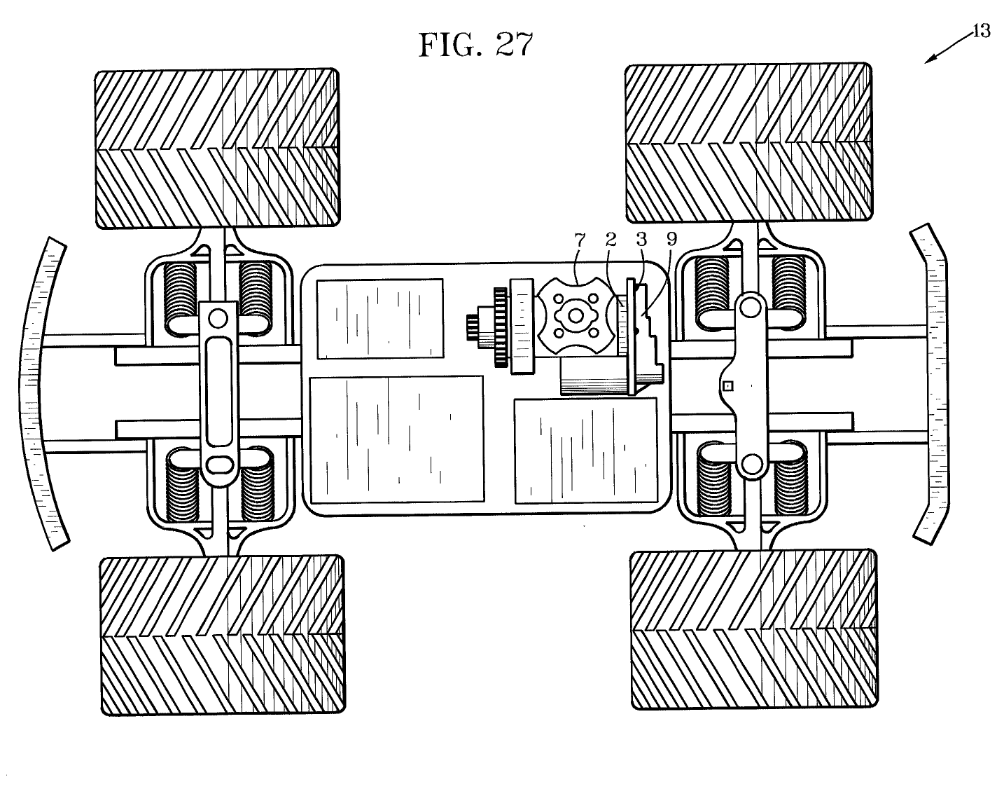

As shown in FIGS. 1, 15, 20-21, and 23, the replacement start shaft 1 has a crankshaft end 19 and a starter end 20. The crankshaft end 19 includes a crank plate 21 that is collinearly concentric with the replacement start shaft 1. Conventionally, model engines of a class for which this invention is intended have the crank plate 21 as one side of a split crank of a crankshaft 22 having a crank axle 23 to which a connecting rod 24 from a piston 25 is connected pivotally as shown in FIGS. 17-18, 21, 23, 25 and 29. The crank axle 23, depicted best in FIG. 18, fits into a crank-axle bay 26 that is shown in FIGS. 1, and 7-9 on the crank plate 21 that is shown in FIGS. 1, 7-11, 13, 15, 17-18, 21, 23, 25 and 29. The crank axle 23 is shown positioned in the crank-axle bay 26 in FIGS. 17, 21, 23, 25 and 29.

The crank plate 21 has a circumference with a predetermined thickness that for most conventional model engines and for the conversional model engine 7, including the O.S.® model engine, is predeterminedly about two millimeters, but can be predeterminedly thicker or thinner for select conversional model engines 7. The bearing portion 12 and the axle portion 10 are concentrically in line intermediate the crank plate 21 and the starter end 20 of the replacement start shaft 1. The bearing portion 12 is extended from the crank plate 21 in a direction towards the starter end 20. The axle portion 10 is extended from the starter end 20 to the bearing portion 12. The bearing portion 12 has a bearing-portion length predeterminedly commensurate with a length of a plate bearing 27 on a starter-end plate that includes the rear adaptor 11 on the conversional model engine 7, the length which for the conversional model engine 7 being preferably proximate twelve and seven-tenths millimeters.

The bearing portion 12 has an outside periphery with a diameter commensurate with rotational bearing contact with an inside periphery of the plate bearing 27, which for the conversional model engine 7 is preferably proximate seven and nine-hundred and thirty-eight thousandths millimeters.

The bearing portion 12 and the axle portion 10 have a combined length, preferably about twenty-five millimeters, that is predetermined to position the starter end 20 and a predetermined length of the axle portion 10 containing the converter one-way clutch 8 in predetermined proximity to a starter coupling 28, shown best in FIG. 16, on the predetermined electric starter 9.

The crank-axle bay 26 on the crank plate 21 is articulated to receive the crank axle 23 of the conversional model engine 7. The crank plate 21 with the crank-axle bay 26 is articulated predeterminedly equivalent to a crank plate with a crank-axle bay of a starting shaft, which includes the pull-start shaft 6, of the conversional model engine 7.

The axle portion 10 is articulated for one-way-clutch communication with one-way-clutching members 29, depicted in FIG. 14, which extend radially from proximate an inside periphery of the converter one-way clutch 8. An external one-way clutch 8 includes an outside periphery with clutch-coupling shoulders 30, depicted in FIGS. 14-15, 23 and 25, that interlock with an insider periphery of the starter coupling 28 of the predetermined electric starter 9, which is depicted in FIG. 16. The clutch-coupling shoulders 30 are preferably hexagonal as shown, but can be splined or otherwise configured for matching the starter coupling 28 if not hexagonal. Distance across flats of the hexagonal clutch-coupling shoulders 30 is preferably about eleven and one-hundred-and-thirteen thousandths millimeters.

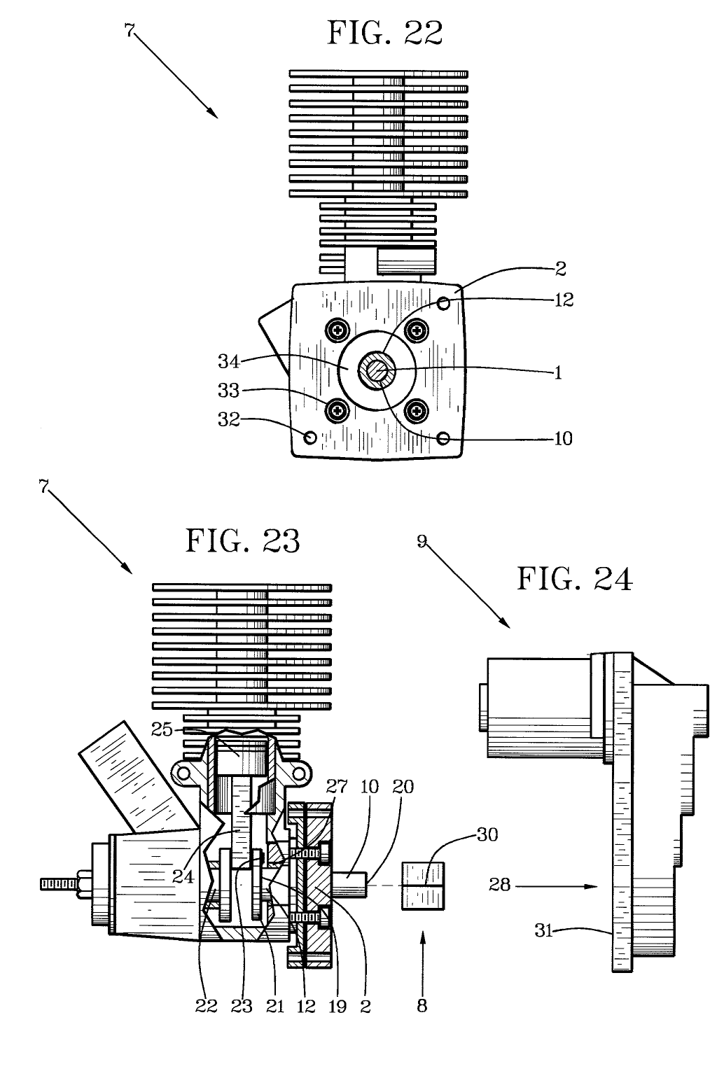

The adaptor plate 2, shown in FIGS. 3-4, 22-23, and 25, includes an adaptor thickness to position a starter-end plate that includes the rear adaptor 11 of the conversional model engine 7 in predetermined proximity to an engine side of a starter plate 31 of the predetermined electric starter 9 in which the starter coupling 28 is positioned. The adaptor thickness is preferably about six and thirty-five hundredths millimeters.

The conversional model engine 7 is a model engine of a class of model engines that includes a model engine having a trade-name identification of O.S.®. The conversional model engine 7 having the trade-name identification of O.S.® includes engine models having model designations of O.S.® 0.12, O.S.® 0.15 and O.S.® FS-265-CX 4-stroke models thereof.

An external one-way clutch 8 includes a one-way clutch of a model-engine starter having a trade name that includes EZ Start.

The predetermined electric starter 9 includes an electric starter having a trade name that includes a designation of EZ Start TRX and a trade name of Traxxas®.

The replacement start shaft 1 and the adaptor plate 2 are articulated to adapt the O.S.® model engine to use of an EZ Start TRX electric starter on a predetermined Traxxas® model truck that include the model truck 13. The replacement start shaft 1 and the adaptor plate 2 are positioned in a converter package 4 for ease of handling and for commercial distribution. The converter package 4 includes an equivalent of the one-way clutch of the model-engine starter having the trade name that includes EZ Start. The converter package 4 includes fasteners 3 that are fastener bolts having machine threading to match fastener threading of the O.S.® model engine for fastening the O.S.® recoil pull starter 14 to the O.S.® model engine prior to removal of the recoil pull starter 14 for its replacement by the EZ Start TRX electric starter. The fastener bolts have lengths to accommodate positioning of the EZ Start TRX electric starter a predetermined distance from the O.S.® model engine for use on the Traxxas® model truck 13. The converter package 4 is designated as a start converter for fitting a Traxxas® electric starter on an O.S.® model engine for use on a Traxxas® model truck 13.

As seen in FIG. 26, the electric starter 9 is attached at an angle that covers a top-left bolt-hole position in the adaptor plate 2. As shown in FIGS. 3-4 and 24, therefore, a fastener-hole pattern in the adaptor plate 2 needs to have only three starter-attachment orifices 32 for the three fasteners 3, but requires four plate-attachment orifices 33 that match orifices for attachment of the rear adaptor 11. A plate countersink 34 is provided for clearance of an external one-way clutch 8.

A new and useful model engine axle-end start converter having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A model engine axle-end start converter comprising:
a converter package;
the converter package containing a replacement start shaft, an adaptor plate, fasteners and assembly instructions;
the replacement start shaft being articulated to replace a pull-start shaft on a conversional model engine and to receive an external one-way clutch for a predetermined electric starter on an axle end of the replacement start shaft;
the adaptor plate being articulated to position the predetermined electric starter on the conversional model engine for use on a predetermined model truck;
the one-way clutch being in coupling-communication intermediate the replacement start shaft and the electric starter; and
the fasteners being attachment bolts having lengths and machine threading for fastening the adaptor plate to the conversional model engine.

2. The model engine axle-end start converter of claim 1 wherein:
the one-way clutch is a converter one-way clutch that is included in the converter package.

3. A model engine axle-end start converter comprising:
a converter package;
the converter package containing a replacement start shaft, an adaptor plate, fasteners and assembly instructions;
the replacement start shaft being articulated to replace an O.S.® pull-start shaft on an O.S.® model engine and to receive a Traxxas® one-way clutch on an axle end of the replacement start shaft;
the adaptor plate being articulated to position a Traxxas® electric starter on the O.S.® model engine for use on a Traxxas® model truck; and
the fasteners being attachment bolts having lengths and machine threads for fastening the adaptor plate to the O.S.® model engine.

4. The model engine axle-end start converter of claim 3 wherein:
the converter package is designated as a start converter for fitting a Traxxas® electric starter on an O.S.® model engine for use on a Traxxas® model truck;

5. The model engine axle-end start converter of claim 3 wherein:
the assembly instructions contain an explanation for removal of an O.S.® pull-start shaft from the O.S.® model engine and for replacement of the O.S.® pull-start shaft with the replacement start shaft.

6. The model engine axle-end start converter of claim 3 wherein:
the assembly instructions contain an explanation for removal of the Traxxas® one-way clutch from the Traxxas® model engine for use on the replacement start shaft.

7. The model engine axle-end start converter of claim 3 wherein:
the assembly instructions contain an explanation for placement of the Traxxas® one-way clutch on the replacement start shaft.

8. The model engine axle-end start converter of claim 3 wherein:
the assembly instructions contain an explanation for attaching the Traxxas® electric starter to the O.S.® model engine which contains the replacement start shaft and the Traxxas® one-way clutch.

9. The model engine axle-end start converter of claim 3 wherein:
the converter package is a see-through plastic container that is reclosable.

10. The model engine axle-end start converter of claim 9 and further comprising:
the converter package includes a closure seal for indicating prior opening of the converter package that has been opened.

11. A model engine axle-end start converter comprising:
a replacement start shaft and an adaptor plate;
the replacement start shaft having a crankshaft end and a starter end;
the crankshaft end including a crank plate that is collinearly concentric with the replacement start shaft;
the crank plate having a circumference with a predetermined thickness;
the replacement start shaft having a bearing portion and an axle portion that are concentrically in line intermediate the crank plate and the starter end of the replacement start shaft;
the bearing portion extending from the crank plate in a direction towards the starter end;
the axle portion extending from the starter end to the bearing portion;
the bearing portion having a bearing-portion length predeterminedly commensurate with a length of a plate bearing on a starter-end plate on a conversional model engine;
the bearing portion having an outside periphery with a diameter commensurate with rotational bearing contact with an inside periphery of the plate bearing;
the bearing portion and the axle portion having a combined length that is predetermined to position the axle end and a predetermined length of the axle portion in predetermined proximity to a starter coupling of a predetermined electric starter;
the crank plate having a crank-axle bay articulated to receive a crank axle of the conversional model engine;
the crank plate with the crank-axle bay being articulated predeterminedly equivalent to a crank plate with a crank-axle bay of a starting shaft of the conversional model engine;
the axle portion being articulated for one-way-clutch communication with one-way-clutching members proximate an inside periphery of an external one-way clutch;
an external one-way clutch having an outside periphery with clutch-coupling shoulders that interlock with an insider periphery of the starter coupling of the predetermined electric starter; and
the adaptor plate including an adaptor thickness to position the starter-end plate of the predetermined engine in predetermined proximity to an engine side of a starter plate of the predetermined electric starter in which the starter coupling is positioned.

12. The model engine axle-end start converter of claim 11 wherein:
the conversional model engine is a model engine of a class of model engines that includes a model engine having a trade-name identification of O.S.®.

13. The model engine axle-end start converter of claim 12 wherein:
the conversional model engine having the trade-name identification of O.S.® includes engine models having model designations of O.S.® 0.12, O.S.® 0.15 and O.S.® FS-265-CX 4-stroke models there of.

14. A model engine axle-end start converter comprising:
a replacement start shaft and an adaptor plate;
the replacement start shaft having a crankshaft end and a starter end;
the crankshaft end including a crank plate that is collinearly concentric with the replacement start shaft;
the crank plate having a circumference and a predetermined thickness;
the replacement start shaft having a bearing portion and an axle portion that are concentrically in line intermediate the crank plate and the starter end of the replacement start shaft;
the bearing portion extending from the crank plate in a direction towards the starter end;
the axle portion extending from the starter end to the bearing portion;
the bearing portion having a bearing-portion length predeterminedly commensurate with a length of a plate bearing on a starter-end plate on a conversional model engine;
the bearing portion having an outside periphery with a diameter commensurate with rotational bearing contact with an inside periphery of the plate bearing;
the bearing portion and the axle portion having a combined length that is predetermined to position the axle end and a predetermined length of the axle portion in predetermined proximity to a starter coupling of a predetermined electric starter;
the crank plate having a crank-axle bay articulated to receive a crank axle of the conversional model engine;
the crank plate with the crank-axle bay being articulated predeterminedly equivalent to a crank plate with a crank-axle bay of a starting shaft of the conversional model engine;
the axle portion being articulated for one-way-clutch communication with one-way-clutching members proximate an inside periphery of an external one-way clutch;
an external one-way clutch having an outside periphery with clutch-coupling shoulders that interlock with an insider periphery of the starter coupling of the predetermined electric starter;
the adaptor plate including an adaptor thickness to position the starter-end plate of the predetermined engine in predetermined proximity to an engine side of a starter plate of the predetermined electric starter in which the starter coupling is positioned;
the circumference of the crank plate is predeterminedly proximate seventeen millimeters;
the thickness of the crank plate is predeterminedly proximate two millimeters;
the bearing-portion length of the bearing portion of the replacement start shaft is predeterminedly proximate twelve-and-one-half millimeters; and
the combined length of the bearing portion and the axle portion of the replacement start shaft is predeterminedly proximate twenty-five millimeters.

15. The model engine axle-end start converter of claim 14 wherein:
the axle portion of the replacement start shaft has an outside diameter that is predeterminedly proximate six and thirty-five-hundredths millimeters.

16. The model engine axle-end start converter of claim 14 wherein:
the one-way clutch includes a one-way clutch of a model-engine starter having a trade name that includes EZ Start.

17. The model engine axle-end start converter of claim 14 wherein:
the clutch-coupling shoulders are hexagonal with a distance of predeterminedly proximate eleven and one-hundred, thirteen thousandths millimeters across hexagonal flats; and
the one-way clutch has an inside diameter predeterminedly greater than proximate six and thirty-five-hundredths millimeters intermediate the one-way clutching members.

18. The model engine axle-end start converter of claim 14 wherein:
the bearing portion of the replacement start shaft has an outside diameter that is predeterminedly proximate seven and nine-hundred, thirty-eight thousandths millimeters.

19. The model engine axle-end start converter of claim 14 wherein:
the adaptor plate includes an attachment surface having a matching configuration of a rear adaptor of the O.S.® model engine.

20. The model engine axle-end start converter of claim 14 wherein:
the electric starter includes an electric starter having a trade name that includes a designation of EZ Start TRX and a trade name of Traxxas®.

21. The model engine axle-end start converter of claim 14 wherein:
the adaptor thickness is predeterminedly proximate six and thirty-five-hundredths millimeters.

22. A model engine axle-end start converter comprising:
a replacement start shaft and an adaptor plate;
the replacement start shaft having a crankshaft end and a starter end;
the crankshaft end including a crank plate that is collinearly concentric with the replacement start shaft;
the crank plate having a circumference and a predetermined thickness;
the replacement start shaft having a bearing portion and an axle portion that are concentrically in line intermediate the crank plate and the starter end of the replacement start shaft;
the bearing portion extending from the crank plate in a direction towards the starter end;
the axle portion extending from the starter end to the bearing portion;
the bearing portion having a bearing-portion length predeterminedly commensurate with a length of a plate bearing on a starter-end plate on a conversional model engine;
the bearing portion having an outside periphery with a diameter commensurate with rotational bearing contact with an inside periphery of the plate bearing;
the bearing portion and the axle portion having a combined length that is predetermined to position the axle end and a predetermined length of the axle portion in predetermined proximity to a starter coupling of a predetermined electric starter;
the crank plate having a crank-axle bay articulated to receive a crank axle of the conversional model engine;
the crank plate with the crank-axle bay being articulated predeterminedly equivalent to a crank plate with a crank-axle bay of a starting shaft of the conversional model engine;
the axle portion being articulated for one-way-clutch communication with one-way-clutching members proximate an inside periphery of an external one-way clutch;
an external one-way clutch having an outside periphery with clutch-coupling shoulders that interlock with an insider periphery of the starter coupling of the predetermined electric starter;
the adaptor plate including an adaptor thickness to position the starter-end plate of the predetermined engine in predetermined proximity to an engine side of a starter plate of the predetermined electric starter in which the starter coupling is positioned;
the circumference of the crank plate is predeterminedly proximate seventeen millimeters;
the thickness of the crank plate is predeterminedly proximate two millimeters;
the bearing-portion length of the bearing portion of the replacement start shaft is predeterminedly proximate twelve-and-one-half millimeters;
the combined length of the bearing portion and the axle portion of the replacement start shaft is predeterminedly proximate twenty-five millimeters;
the axle portion of the replacement start shaft has an outside diameter that is predeterminedly proximate six and thirty-five-hundredths millimeters;
the one-way clutch includes a one-way clutch of a model-engine starter having a trade name that includes EZ Start;
the clutch-coupling shoulders are hexagonal with a distance of predeterminedly proximate eleven and one-hundred, thirteen thousandths millimeters across hexagonal flats;
the one-way clutch has an inside diameter predeterminedly greater than proximate six and thirty-five-hundredths millimeters intermediate the one-way clutching members;
the bearing portion of the replacement start shaft has an outside diameter that is predeterminedly proximate seven and nine-hundred, thirty-eight thousandths millimeters;
the adaptor plate includes a match fit of a rear adaptor of the O.S.® model engine;
the electric starter includes an electric starter having a trade name that includes a designation of EZ Start TRX and a trade name of Traxxas®; and
the adaptor thickness is predeterminedly proximate six and thirty-five-hundredths millimeters.

23. The model engine axle-end start converter of claim 22 wherein:
the replacement start shaft and the adaptor plate are articulated to adapt the O.S.® model engine to use of the EZ Start TRX electric starter on a predetermined Traxxas® model truck.

24. The model engine axle-end start converter of claim 22 wherein:
the replacement start shaft and the adaptor plate are positioned in a converter package for distribution.

25. The model engine axle-end start converter of claim 24 wherein:
the converter package includes a converter one-way clutch that is an equivalent of the one-way clutch of the model-engine starter having the trade name that includes EZ Start.

26. The model engine axle-end start converter of claim 24 wherein:
the converter package includes fastener bolts having machine threading to match fastener threading of the O.S.® model engine for fastening an O.S.® recoil pull start to the O.S.® model engine prior to removal of the recoil pull starter for its replacement by the EZ Start TRX electric starter; and
the fastener bolts have lengths to accommodate positioning of the EZ Start TRX electric starter a predetermined distance from the O.S.® model engine for use on the Traxxas® model truck.

27. The model engine axle-end start converter of claim 24 wherein:
the converter package is designated as a start converter for fitting a Traxxas® electric starter on an O.S.® model engine for use on a Traxxas® model truck;

28. The model engine axle-end start converter of claim 24 wherein:
the assembly instructions contain an explanation for removal of an O.S.® pull-start shaft from the O.S.® model engine; and
the assembly instructions contain an explanation for replacement of the O.S.® pull-start shaft with the replacement start shaft.

29. The model engine axle-end start converter of claim 24 wherein:
the assembly instructions contain an explanation for removal of the Traxxas® one-way clutch from the Traxxas® model engine for use on the replacement start shaft.

30. The model engine axle-end start converter of claim 24 wherein:
the assembly instructions contain an explanation for placement of the Traxxas® one-way clutch on the replacement start shaft.

31. The model engine axle-end start converter of claim 24 wherein:
the assembly instructions contain an explanation for attaching the Traxxas® electric starter to the O.S.® model engine which contains the replacement start shaft and the Traxxas® one-way clutch.

32. The model engine axle-end start converter of claim 24 wherein:
the converter package is a see-through plastic container that is reclosable.

33. The model engine axle-end start converter of claim 32 wherein:
the converter package includes a closure seal for indicating prior opening of the converter package that has been opened.
